(19) United States
(12) Patent Application Publication
(10) Pub. No.: US 2020/0304575 A1
(43) Pub. Date: Sep. 24, 2020

(54) AIR CONDITIONING DATA COMMUNICATION DEVICE, AIR CONDITIONING DATA COMMUNICATION METHOD AND PROGRAM

(71) Applicant: Mitsubishi Electric Corporation, Tokyo (JP)

(72) Inventors: Takahiro ITO, Tokyo (JP); Makoto KATSUKURA, Tokyo (JP); Takeru KUROIWA, Tokyo (JP); Masanori IMAGAWA, Tokyo (JP); Taichi ISHIZAKA, Tokyo (JP)

(21) Appl. No.: 16/491,812

(22) PCT Filed: May 26, 2017
(86) PCT No.: PCT/JP2017/019743

§ 371 Date: Sep. 6, 2019

(51) Int. Cl. H04L 29/08; H04L 12/801; H04L 12/927; G06Q 20/12; G06Q 10/10; G06Q 10/06; G06Q 20/14; G06Q 50/06; F24F 11/47; F24F 11/64; F24F 11/65

(52) U.S. Cl. CPC H04L 67/12; H04L 47/12; H04L 47/805; G06Q 20/127; G06Q 10/10; G06Q 10/06312; F24F 2110/10; G06Q 50/06; F24F 11/47; F24F 11/64; F24F 11/65; G05B 2219/2614; G06Q 20/14

(57) ABSTRACT

An air conditioning data communication device includes a data acquisition unit, a transmission schedule adjusting unit, and a data transmission unit. The data acquisition unit acquires data about an air conditioner. The transmission schedule adjusting unit creates a schedule for transmission of data acquired by the data acquisition unit to a server, and adjusts the schedule by changing a transmission time to allow the data to be transmittable to the server when the data is not all transmittable to the server within a billing cycle included in fee plan information. The data transmission unit transmits data to the server in accordance with the schedule created by the transmission schedule adjusting unit.

### TECHNICAL FIELD

The present disclosure relates to an air conditioning data communication device, an air conditioning data communication method, and an air conditioning data communication program.

### BACKGROUND ART

Mobile data communications have been widely performed using devices such as mobile phones, smartphones, and mobile routers. The mobile communication speed changes depending on the conditions such as the state of radio waves or data traffic conditions. The cost of data communications also changes depending on the conditions such as a fee plan subscribed by a user to a provider of a mobile data transmission service, or the volume of communication data. Thus, techniques for saving the cost of data communications have been developed. For example, Patent Literature 1 describes a data transfer communication device that estimates communication fees based on the state of radio waves and the transmission data volume in mobile data communications, and disconnects the communication line to save communication costs when the estimate fee is rather expensive.

### CITATION LIST

### Patent Literature

Patent Literature 1: Unexamined Japanese Patent Application Kokai Publication No. 2000-165331

### SUMMARY OF INVENTION

### Technical Problem

The data transfer communication device described in Patent Literature 1 disconnects the communication line for every expensive data communication to save the communication cost. However, the data transfer communication device only saves the communication cost of every data communication, and cannot enable cost-effective data communications over a long period of time such as several months or years.

One or more aspects of the present disclosure are directed to an air conditioning data communication device, an air conditioning data communication method, and an air conditioning data communication program that enable cost-effective data communications over a long period of time.

### Solution to Problem

An air conditioning data communication device includes communication means for communicating with a server, fee plan storage means for storing fee plan information including a billing cycle under subscription to a provider of a network used for communications performed by the communication means, data acquiring means for acquiring data about an air conditioner, transmission schedule adjusting means for creating a schedule for transmission of the data acquired by the data acquiring means to the server, and adjusting the schedule by changing a transmission time to allow the data to be transmitted to the server when the data is not all transmittable to the server within the billing cycle, and data transmitting means for transmitting the data to the server through the communication means in accordance with the schedule created by the transmission schedule adjusting means.

### Advantageous Effects of Invention

The above aspect of the present disclosure enables cost-effective data communications over a long period of time with an air conditioning data communication device for adjusting a data transmission schedule based on fee plan information and a data volume.

### BRIEF DESCRIPTION OF DRAWINGS

FIG. 1 is a system configuration diagram of an air conditioning data communication system according to Embodiment 1 of the present disclosure;

FIG. 2 is a functional block diagram of the air conditioning data communication device according to Embodiment 1;

FIG. 3 is a table showing an example of data stored in an air conditioning data storage in the air conditioning data communication device according to Embodiment 1;

FIG. 4 is a table showing an example of data stored in a fee plan storage in the air conditioning data communication device according to Embodiment 1;

FIG. 5 is a table showing an example of data stored in a communication speed storage in the air conditioning data communication device according to Embodiment 1;

FIG. 6 is a table showing an example of data stored in an annual schedule storage in the air conditioning data communication device according to Embodiment 1;

FIG. 7 is a flowchart of a data acquisition process performed by the air conditioning data communication device according to Embodiment 1;

FIG. 8 is a flowchart of a communication speed measurement process performed by the air conditioning data communication device according to Embodiment 1;

FIG. 9 is a flowchart of an annual schedule creation process performed by the air conditioning data communication device according to Embodiment 1;

FIG. 10 is a table showing an example of air conditioning data about an air conditioner in an operation state transmitted by the air conditioning data communication device according to Embodiment 1;

FIG. 11 is a flowchart of an annual schedule adjustment process performed by the air conditioning data communication device according to Embodiment 1;

FIG. 12 is a table showing an example of an annual schedule adjusted through the annual schedule adjustment process performed by the air conditioning data communication device according to Embodiment 1;

FIG. 13 is a flowchart of a transmission schedule creation process performed by the air conditioning data communication device according to Embodiment 1;

FIG. 14 is a table showing an example of air conditioning data about the air conditioner in a non-operation state transmitted by the air conditioning data communication device according to Embodiment 1;

FIG. 15 is a table showing an example of air conditioning data excluding low-priority data transmitted by the air conditioning data communication device according to Embodiment 1;

FIG. 16 is a table showing an example of air conditioning data only including high-priority data transmitted by the air conditioning data communication device according to Embodiment 1;

FIG. 17 is a flowchart of a data transmission process performed by the air conditioning data communication device according to Embodiment 1;

FIG. 18 is a flowchart of an annual schedule adjustment process performed by an air conditioning data communication device according to Modification 3 of Embodiment 1;

FIG. 19 is a table showing an example of an annual schedule adjusted through the annual schedule adjustment process performed by the air conditioning data communication device according to Modification 3 of Embodiment 1;

FIG. 20 is a functional block diagram of an air conditioning data communication device according to Embodiment 2 of the present disclosure;

FIG. 21 is a table showing an example of data stored in a monthly schedule storage in the air conditioning data communication device according to Embodiment 2;

FIG. 22 is a flowchart of a monthly schedule creation process performed by the air conditioning data communication device according to Embodiment 2;

FIG. 23 is a table showing an example of a monthly schedule adjusted through the monthly schedule creation process performed by the air conditioning data communication device according to Embodiment 2;

FIG. 24 is a flowchart of a data transmission process performed by the air conditioning data communication device according to Embodiment 2; and

FIG. 25 shows a hardware configuration of an air conditioning data communication device according to one or more embodiments of the present disclosure.

### DESCRIPTION OF EMBODIMENTS

An air conditioning data communication device, an air conditioning data communication method, and an air conditioning data communication program according to one or more embodiments of the present disclosure will now be described in detail with reference to the drawings. Throughout the drawings, the same or similar components are denoted by the same reference numerals.

### Embodiment 1

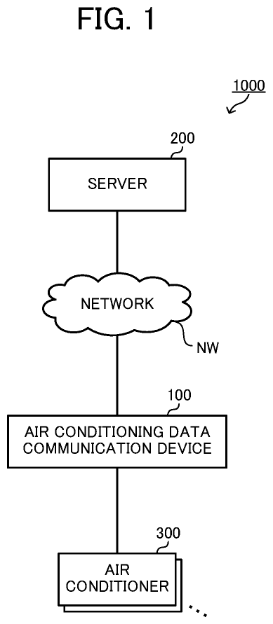

As shown in FIG. 1, an air conditioning data communication system 1000 according to Embodiment 1 of the present disclosure includes an air conditioning data communication device 100, a server 200, and air conditioners 300. The air conditioning data communication device 100 and the server 200 can communicate with each other with a network NW. Examples of the network NW include Long-Term Evolution (LTE, registered trademark), mobile worldwide interoperability for microwave access (WiMAX), third generation (3G), and fourth generation (4G). LTE is used herein.

The air conditioning data communication device 100 is mainly installed in a building and is connected to one or more air conditioners 300 in the building to communicate with the air conditioners 300. The air conditioning data communication device 100 receives data from the air conditioners 300 and manages the air conditioners 300. One air conditioning data communication device 100 may be installed for each building, or for each floor of one building to manage the air conditioners 300 on the floor. Beside a building, the air conditioning data communication device 100 may be installed in, for example, a house, an apartment, a factory, or a warehouse.

The air conditioning data communication device 100 collects data from each air conditioner 300, and transmits the collected data to the server 200 with the network NW. Examples of the data collected by the air conditioning data communication device 100 include operation data, power consumption data, and sensor outputs of each air conditioner 300. The server 200 analyzes such data and generates analysis results to be used for checking a breakdown, an abnormal operation, a breakdown sign, or coolant leakage of each air conditioner 300, and for energy saving control.

The communication fee can be saved by using a communication line of an inexpensive subscriber identity module (SIM) provided by a mobile virtual network operator (MVNO) as the network NW. The communication line usually has a fixed data communication volume limit allowed per month, and allows an unconsumed data volume to be carried over to the next month by a maximum predetermined volume. The air conditioners 300 operating at a low ratio with less frequent data communications in spring and fall can carry over the remaining volume to summer and winter during which the air conditioners 300 operate at a high ratio. The air conditioners 300 thus allow more frequent data communications at the same communication fee during a high operation rate, and achieve cost-effective data communications. The air conditioning data communication device 100 creates communication schedules achieving such cost-effective data communications. The mechanism will now be described.

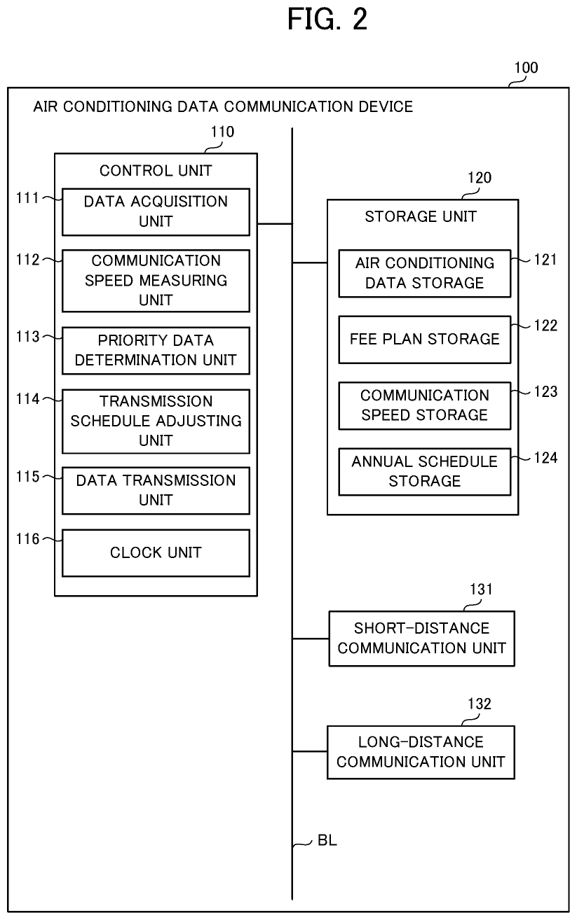

As shown in FIG. 2, the air conditioning data communication device 100 includes, as functional components, a control unit 110, a storage unit 120, a short-distance communication unit 131, and a long-distance communication unit 132. These units are electrically connected to one another with a bus line BL.

The control unit 110 includes a central processing unit (CPU), and executes a program stored in the storage unit 120 to implement the functions of individual units (a data acquisition unit 111, a communication speed measuring unit 112, a priority data determination unit 113, a transmission schedule adjusting unit 114, a data transmission unit 115, and a clock unit 116). The control unit 110 has a multithreading function to execute multiple processes in parallel.

The data acquisition unit 111 acquires air conditioning data from the air conditioners 300 through the short-distance communication unit 131, and stores the data into an air conditioning data storage 121 (described later). The air conditioning data is operation data about the air conditioners 300. The air conditioning data specifically includes the operation state (ON or OFF), the operation mode (cooling, heating, or dehumidifying), the temperature setting, the airflow rate, the wind direction, various sensor outputs (room temperature, room humidity, outside temperature, coolant temperature, coolant amount, and compressor output), power consumption, and the communication state. The communication state is data indicating whether the air conditioning data communication device 100 and the air conditioners 300 communicate normally. These sets of operation data are examples, and may be changed or deleted or may include other data as appropriate. The air conditioning data communication device 100 collects air conditioning data about the air conditioner 300 through the data acquisition unit 111. The data acquisition unit 111 functions as data acquiring means.

The communication speed measuring unit 112 measures the data communication speed at which the air conditioning data communication device 100 communicates with the server 200 through the long-distance communication unit 132. After measuring the data communication speed, the communication speed measuring unit 112 stores the measurement results into a communication speed storage 123 (described later). The communication speed measuring unit 112 functions as communication speed measuring means.

The priority data determination unit 113 determines data to be transmitted with priority when the air conditioning data acquired by the data acquisition unit 111 is not all transmittable to the server 200. The expression “the air conditioning data is not all transmittable to the server 200” intends to mean, for example, 5 GB of air conditioning data is collected during the month whereas communicating data of less than 5 GB is allowed per month by the subscription to a provider of the network NW. In another example, 5 GB of air conditioning data is collected during the month whereas communicating data of less than 5 GB is transmittable in accordance with the data communication speed measured by the communication speed measuring unit 112. In such cases, only the data to be transmitted with priority determined by the priority data determination unit 113 is transmitted to the server 200 to reduce the communication data volume. More specifically, the priority data determination unit 113 determines the coolant temperature, the coolant amount, the compressor pressure, and the communication state associated with the malfunctions of the air conditioners 300 to be high-priority data, data indicating the power consumption of the air conditioners 300 to be intermediate-priority data, and other operation data to be low-priority data. The priority data determination unit 113 functions as priority data determining means.

The transmission schedule adjusting unit 114 creates a schedule for the air conditioning data communication device 100 transmitting the air conditioning data to the server 200. The transmission schedule adjusting unit 114 then adjusts the transmission schedule as appropriate to enhance the cost effect based on the subscribed fee plan with the provider of the network NW. Creating and adjusting the transmission schedule will be described in detail later. The transmission schedule adjusting unit 114 functions as transmission schedule adjusting means.

In accordance with the transmission schedule created and adjusted by the transmission schedule adjusting unit 114, the data transmission unit 115 transmits the air conditioning data stored in the air conditioning data storage 121 through the long-distance communication unit 132 to the server 200. The data transmission unit 115 functions as data transmitting means.

The clock unit 116 keeps the current time together with the date. The clock unit 116 can also acquire the start time and the end time, and acquire the time elapsed from the start time to the end time by calculating the difference between the start time and the end time. The clock unit 116 also functions as a timer.

The storage unit 120 includes a read only memory (ROM) and a random access memory (RAM) as hardware. The storage unit 120 stores programs executable by the control unit 110 and associated data. The storage unit 120 includes, as functional units, an air conditioning data storage 121, a fee plan storage 122, a communication speed storage 123, and an annual schedule storage 124. The storage unit 120 functions as storage means.

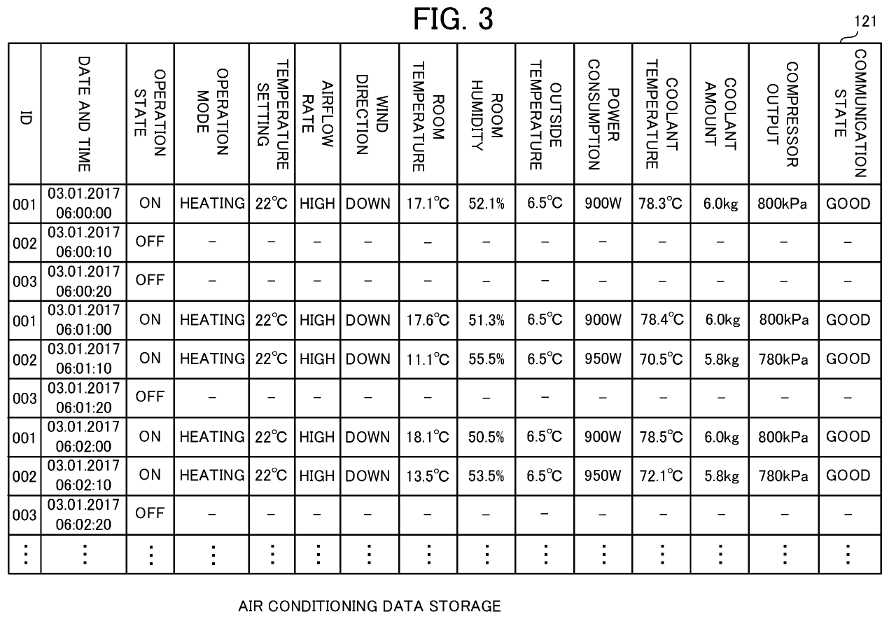

As shown in FIG. 3, the air conditioning data storage 121 stores the air conditioning data acquired by the data acquisition unit 111 together with the acquired date and time and the identifiers (IDs) of the air conditioners 300. The air conditioning data storage 121 functions as air conditioning data storage means.

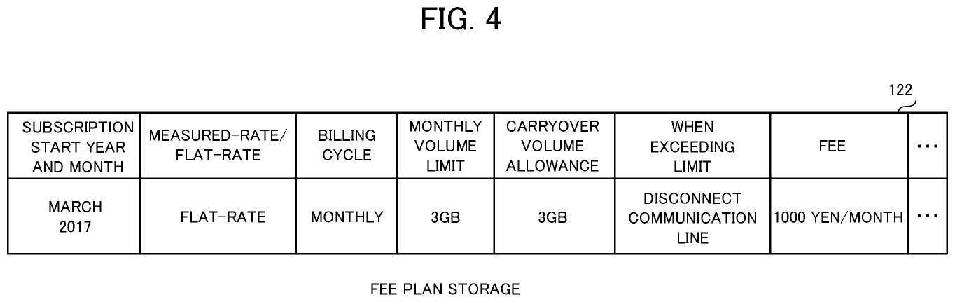

As shown in FIG. 4, the fee plan storage 122 stores information about the subscribed fee plan with a provider of the network NW. The fee plan mainly includes a measured-rate system in which the price increases as the communication data volume increases, and a flat-rate system in which the price remains unchanged up to the data volume limit per unit period. The unit period is usually the same as a payment period (billing cycle), and normally a month. The unit period herein is the same as the billing cycle. In the flat-rate system, the price (monthly rate for a monthly billing cycle) changes depending on the communication data volume limit per billing cycle. The flat-rate system plan responds to the communication data volume exceeding the limit by several options including disconnecting the communication line, reducing the communication speed, and charging an additional fee. Some plans allow a predetermined portion of an unconsumed data limit to be carried over to the next period at maximum (next month for the monthly billing cycle). The fee plan storage 122 stores plan information, such as the subscription start year and month, whether the measured-rate system or flat-rate system is selected, the billing cycle, measured-rate information for the measured-rate system, the volume limit per billing cycle for the flat-rate system (monthly volume limit for the monthly billing cycle), the portion allowed to be carried over (carryover volume allowance), options for the volume exceeding the allowance, and information about the flat rate. The subscription start year and month is the year and month in which the user starts to subscribe to the provider. In the example shown in FIG. 4, the fee plan storage 122 stores the fee plan of the subscription start year and month of March 2017, billed monthly, a monthly volume limit of 3 GB, a carryover volume allowance of 3 GB, the communication line to be disconnected in response to the volume exceeding the limit, and the flat-rate system of 1000 yen per month. The fee plan storage 122 functions as fee plan storage means. The present embodiment describes a fee plan billed monthly.

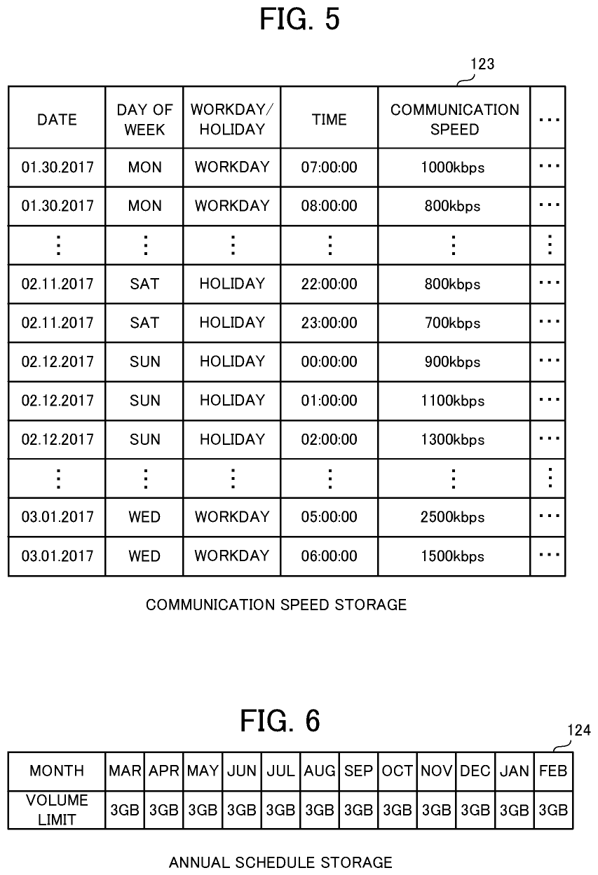

As shown in FIG. 5, the communication speed storage 123 stores the communication speed measured by the communication speed measuring unit 112, or the data communication speed at which the communication is performed with the server 200 through the long-distance communication unit 132. The communication speed is measured through a communication speed measurement process (described later). The communication speed storage 123 stores the communication speed on the hour each day for a communication speed storage period. The communication speed storage period is a period for which the communication speed measured by the communication speed measuring unit 112 is stored into the communication speed storage 123. In the example shown in FIG. 5, a duration of 30 days is set as the communication speed storage period to store data for the past 30 days. Data with an expired communication speed storage period is deleted to allow constant storage of data for the latest communication speed storage period. The communication speed storage 123 functions as communication speed storage means.

As shown in FIG. 6, the annual schedule storage 124 stores an annual transmission schedule created by the transmission schedule adjusting unit 114. The annual transmission schedule is created through an annual schedule creation process described below. FIG. 6 shows an example of a transmission schedule in which the volume limit per month of 3 GB is allocated as the monthly volume limit based on the fee plan shown in FIG. 4. The annual schedule storage 124 functions as annual schedule storage means.

The short-distance communication unit 131 is a communication interface for communicating with the air conditioners 300. The short-distance communication unit 131 may be any communication interface that enables communications with the air conditioners 300. The short-distance communication unit 131 may be a communication interface that complies with a wired telecommunication standard such as Ethernet (registered trademark) or a universal serial bus (USB), or with a wireless telecommunication standard such as wireless LAN or Bluetooth (registered trademark). The short-distance communication unit 131 may be installed in the air conditioning data communication device 100 or may be an external adapter. The air conditioners 300 also include a communication interface that enables communications with the short-distance communication unit 131. The communication interface may also be installed in each air conditioner 300 or may be an external adapter.

The short-distance communication unit 131 is not limited to one communication interface. For example, the short-distance communication unit 131 for communicating with a first air conditioner 300 may include a USB, and the short-distance communication unit 131 for communicating with a second air conditioner 300 may include a wireless LAN. In this manner, the short-distance communication unit 131 may include multiple communication interfaces. The short-distance communication unit 131 functions as short-distance communication means.

The long-distance communication unit 132 is a communication interface for communicating with the server 200 with the network NW in a mobile environment. The long-distance communication unit 132 may be any communication interface that enables mobile communications with the server 200, such as a communication interface that complies with a wireless telecommunication standard of LTE (registered trademark), or 3G. The server 200 also includes a communication interface that enables communications with the long-distance communication unit 132 with the network NW. The long-distance communication unit 132 functions as communication means.

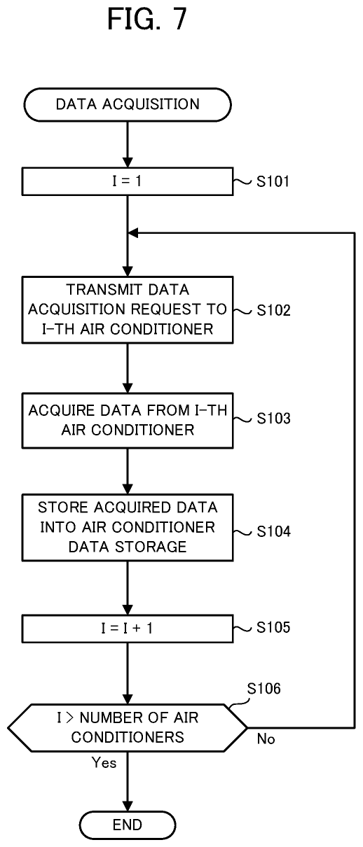

A data acquisition process in which the air conditioning data communication device 100 acquires air conditioning data from the air conditioners 300 will now be described with reference to FIG. 7. The process is started at time intervals defined for data acquisition. The data acquisition time intervals may be defined as appropriate. In this example, the data acquisition time interval is defined to be one minute. For example, every upon the minute of the current time is incremented to have zero second, the air conditioning data communication device 100 starts the data acquisition process described below.

First, the data acquisition unit 111 in the air conditioning data communication device 100 substitutes one to variable I (step S101). Variable I indicates the ordinal number of the air conditioner 300 from which data is acquired during the acquisition process among all the air conditioners 300. Subsequently, the data acquisition unit 111 transmits a data acquisition request packet to an I-th air conditioner 300 through the short-distance communication unit 131 (step S102). The data acquisition request packet is a packet for requesting each air conditioner 300 to transmit the air conditioning data.

When receiving the data acquisition request packet, each air conditioner 300 transmits the air conditioning data to the air conditioning data communication device 100. As described above, the air conditioning data is operation data about the air conditioner 300. When the air conditioner 300 is in a non-operation state, the air conditioning data indicating air conditioning OFF is simply transmitted. The data acquisition unit 111 in the air conditioning data communication device 100 then acquires air conditioning data from the I-th air conditioner 300 (step S103). Step S103 is also referred to as a data acquiring step.

The data acquisition unit 111 stores the acquired air conditioning data into the air conditioning data storage 121 (step S104). The data acquisition unit 111 links the acquired air conditioning data with the ID of the I-th air conditioner 300 and the acquired date and time of the air conditioning data, and stores the data in the manner shown in FIG. 3. The data acquisition unit 111 then increments variable I by one (step S105), and determines whether the incremented variable I is smaller than or equal to the number of air conditioners 300 (step S106). When variable I incremented by one is smaller than or equal to the number of air conditioners 300 (No in step S106), the processing returns to step S102. When variable I incremented by one is larger than the number of air conditioners 300 (Yes in step S106), the data acquisition process ends.

Through the data acquisition process described above, the air conditioning data communication device 100 acquires air conditioning data from each air conditioner 300, and stores the acquired air conditioning data into the air conditioning data storage 121.

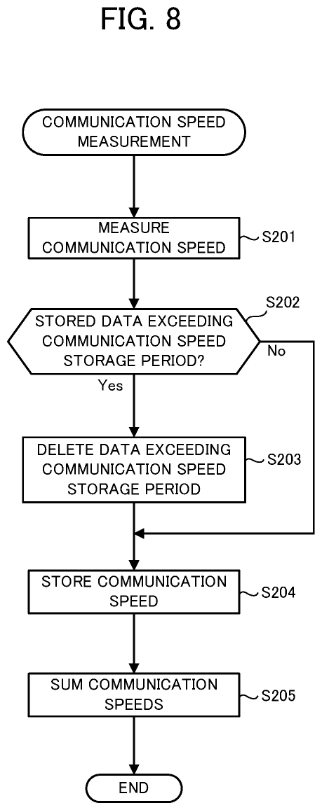

A communication speed measurement process in which the air conditioning data communication device 100 measures the communication speed of the network NW will now be described with reference to FIG. 8. The process is started at time intervals defined for communication speed measurement. The communication speed measurement time intervals may be defined as appropriate. In this example, the communication speed measurement time interval is defined to be one hour. For example, the air conditioning data communication device 100 starts the data acquisition process every hour on the hour.

First, the communication speed measuring unit 112 calculates the communication speed at which data is transmitted to the server 200 through the long-distance communication unit 132 (step S201). The communication speed measuring unit 112 calculates the communication speed by dividing the size of data transmitted to the server 200 by time taken for the transmission. Data transmitted may be dummy data prepared for measuring the communication speed or air conditioning data transmitted through a data transmission process (described later). Step S201 is also referred to as a communication speed measurement step.

Subsequently, the communication speed measuring unit 112 determines whether the communication speed storage 123 stores the communication speed for a period exceeding the communication speed storage period (step S202). When the communication speed storage 123 stores the communication speed for a period exceeding the communication speed storage period (Yes in step S202), data about the communication speed for the period exceeding the communication speed storage period is deleted (step S203). When the communication speed storage 123 does not store the communication speed for a period exceeding the communication speed storage period (No in step S202), the processing advances to step S204.

The communication speed measuring unit 112 then stores the communication speed measured in step S201 into the communication speed storage 123 (step S204). In step S204, as shown in FIG. 5, the communication speed storage 123 stores the measured date, time, day of the week, and workday/holiday information representing either a workday or holiday, besides the communication speed measured by the communication speed measuring unit 112.

The communication speed measuring unit 112 then sums and averages the communication speeds stored in the communication speed storage 123 for each time slot separately between workdays and holidays (step S205), and ends the communication speed measurement process. The summed communication speeds may be sorted between holidays and workdays, or specifically between days defined as holidays by Article 1 of Act on Holidays of Administrative Organs (Sundays, Saturdays, national holidays, and New Year holidays), and other days as workdays, or may be sorted in more detail. For example, the communication speed may be sorted between Mondays to Fridays other than national holidays, national holidays on Monday to Friday, Saturdays other than national holidays, national holidays on Saturday, and Sundays. Such summation may be performed using the minimum speed in each time slot, instead of the average speed in each time slot. The use of the minimum speed allows more precise determination as to whether air conditioning data is transmittable in a monthly schedule creation process described later, and lowers the likelihood that the air conditioning data cannot be transmitted as specified in the monthly schedule under the communication speed lower than expected.

The average communication speed is obtained for each time slot for each day through the communication speed measurement process described above.

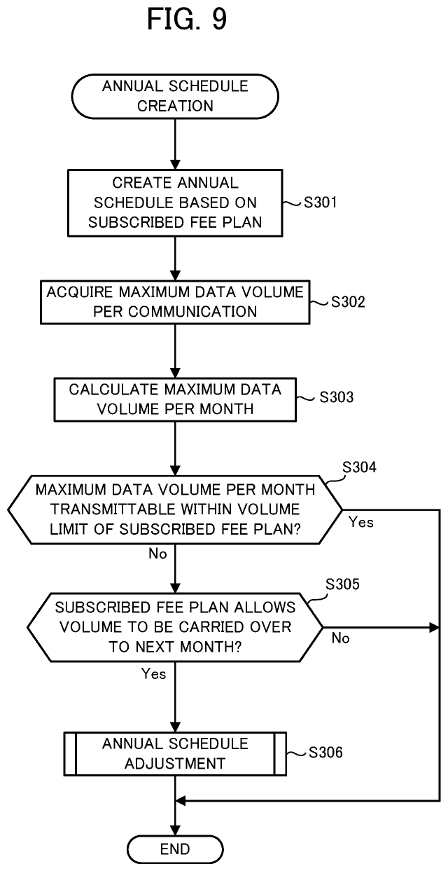

An annual schedule creation process in which the air conditioning data communication device 100 creates an annual schedule for allocation of a volume limit to each month of a year will now be described with reference to FIG. 9. The process is performed at the beginning of every month.

First, the transmission schedule adjusting unit 114 creates an annual schedule based on the billing cycle and the monthly volume limit of the fee plan stored in the fee plan storage 122, and stores the annual schedule into the annual schedule storage 124 (step S301). For the fee plan shown in FIG. 4 that is billed monthly with the monthly volume limit of 3 GB, for example, the transmission schedule adjusting unit 114 creates an annual schedule of a monthly volume limit of 3 GB as shown in FIG. 6. When subscribing a fee plan with a measured-rate system billed monthly, a user sets a maximum monthly rate with the air conditioning data communication device 100 in advance, and the transmission schedule adjusting unit 114 creates an annual schedule with a maximum volume transmittable at the maximum monthly rate as a volume limit. In step S301, the transmission schedule adjusting unit 114 acquires fee plan information stored in the fee plan storage 122. Thus, step S301 is also referred to as a fee plan information acquiring step.

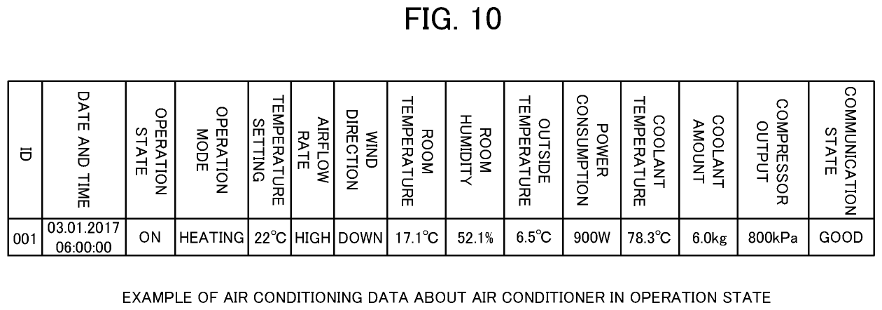

The transmission schedule adjusting unit 114 then acquires a maximum data volume per communication of the air conditioning data (step S302). When, for example, the air conditioning data storage 121 stores the air conditioning data as shown in FIG. 3, the maximum data volume per transmission may be, for example, the data shown in FIG. 10. More specifically, a maximum data volume per communication is the communication data volume of the air conditioning data transmitted from the air conditioner 300 to which the communication data volume corresponding to the ID and date and time is added. For example, when the ID has 2 bytes, the date and time has 6 bytes, each of the operation state, the operation mode, the temperature setting, the airflow rate, the wind direction, and the communication state has 1 byte, and each of other sets of air conditioning data has 2 bytes, the volume per communication is 2+6+1×6+2×7=28 bytes.

Subsequently, the transmission schedule adjusting unit 114 calculates the maximum data volume transmitted within a month based on the communication data volume per communication acquired in step S302, the number of air conditioners 300, and the data acquisition time interval (step S303). For example, the communication data volume per communication is 28 bytes, the number of air conditioners 300 is three, and the data acquisition time interval is one minute. In this case, the maximum data volume transmitted within a month is 28 (byte/min per device)×3 (number of devices)×60 (min/h)×24 (h/day)×31 (days)=3749760 bytes 3.75 MB.

Subsequently, the transmission schedule adjusting unit 114 determines whether the maximum data volume transmitted within a month calculated in step S303 is transmittable within the range of the monthly volume limit of the fee plan stored in the fee plan storage 122 (step S304). When the data is transmittable (Yes in step S304), the annual schedule creation process ends.

When the data is not transmittable (No in step S304), the transmission schedule adjusting unit 114 determines whether the fee plan stored in the fee plan storage 122 allows the data to be carried over to the next month (step S305). When the data cannot be carried over (No in step S305), the annual schedule creation process ends. When the data can be carried over (Yes in step S305), the transmission schedule adjusting unit 114 performs an annual schedule adjustment process (step S306), and ends the annual schedule creation process. Step S306 is also referred to as a transmission schedule adjusting step.

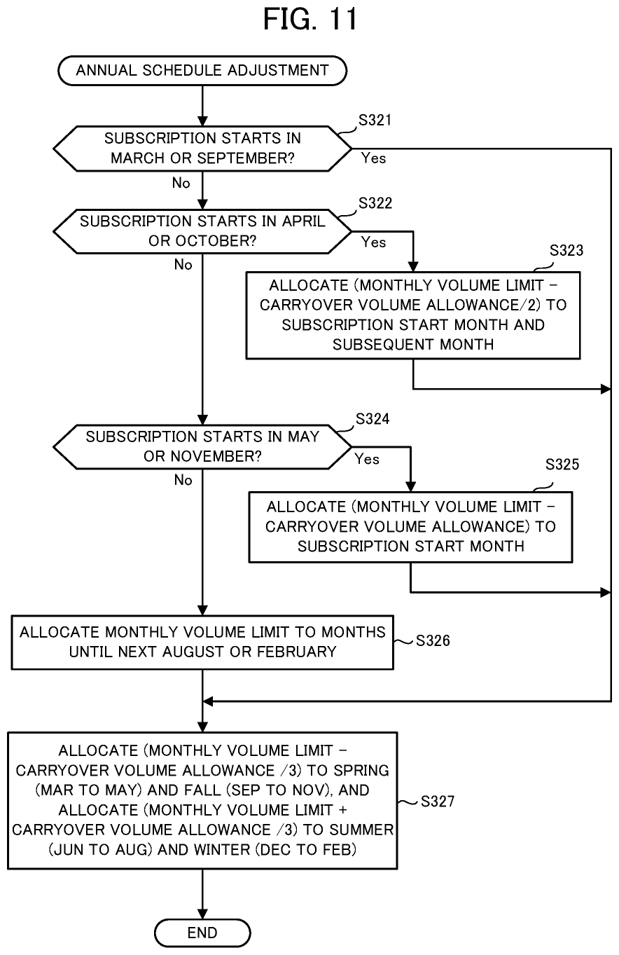

The annual schedule adjustment process performed in step S306 will now be described with reference to FIG. 11.

First, the transmission schedule adjusting unit 114 determines whether the subscription start month of the fee plan stored in the fee plan storage 122 is March or September (step S321). When the subscription start month is March or September (Yes in step S321), the carryover volume allowance is subtracted from the monthly volume limit of the fee plan stored in the fee plan storage 122, and the difference is divided by 3. The resultant is allocated as the volume limit for spring (March to May) and fall (September to November). Further, the carryover volume allowance is added to the monthly volume limit, and the sum is divided by 3. The resultant is allocated as the volume limit for summer (June to August) and winter (December to February) (step S327), and the annual schedule adjustment process ends.

When the subscription start month is neither March nor September (No in step S321), the transmission schedule adjusting unit 114 determines whether the subscription start month is April or October (step S322). When the subscription start month is April or October (Yes in step S322), the transmission schedule adjusting unit 114 allocates the volume obtained by subtracting the carryover volume allowance from the monthly volume limit and dividing the difference by 2 as the volume limit of the subscription start month and the subsequent month (step S323), and the processing advances to step S327.

When the subscription start month is neither April nor October (No in step S322), the transmission schedule adjusting unit 114 determines whether the subscription start month is May or November (step S324). When the subscription start month is May or November (Yes in step S324), the transmission schedule adjusting unit 114 allocates the volume obtained by subtracting the carryover volume allowance from the monthly volume limit as the volume limit of the subscription start month (step S325), and the processing advances to step S327.

When the subscription start month is neither May nor November (No in step S324), the transmission schedule adjusting unit 114 allocates the monthly volume limit for the months until the subsequent August or February as the volume limit (step S326), and the processing advances to step S327.

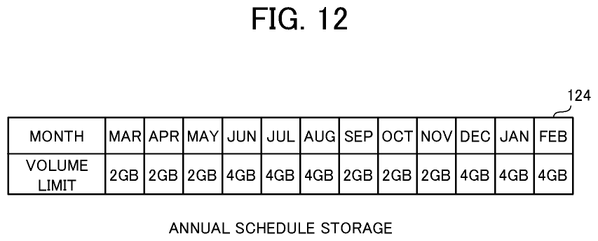

Through the annual schedule creation process and the annual schedule adjustment process described above, the annual schedule storage 124 stores the maximum data volume per month and the annual transmission schedule created based on the subscribed fee plan. When, for example, the maximum data volume per month exceeds 3 GB and the subscribed fee plan is the plan shown in FIG. 4, the annual schedule storage 124 stores information shown in FIG. 12 through the above annual schedule adjustment process. Thus, the annual schedule adjustment process increases the volume limit for a high operational period (summer and winter) in which the air conditioners 300 operate at a high ratio to the volume limit more than the volume limit for a low operational period (spring and fall) in which the air conditioners 300 operate at a low ratio.

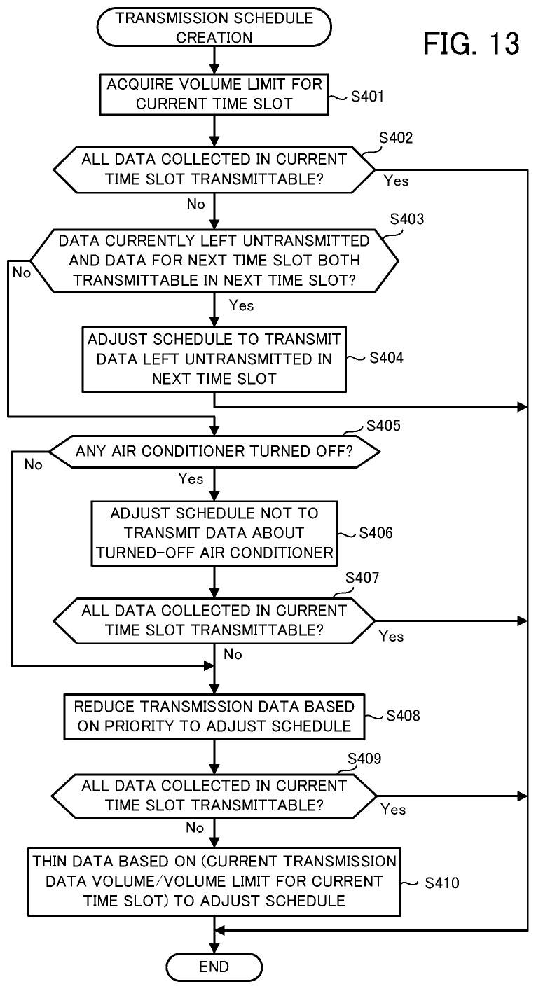

A transmission schedule creation process in which the air conditioning data communication device 100 creates a schedule for transmitting air conditioning data stored in the air conditioning data storage 121 will now be described with reference to FIG. 13. The process is started at time intervals defined for data transmission. The data transmission time intervals are the time intervals at which the air conditioning data is transmitted to the server 200 through a data transmission process described later. The data transmission time intervals may be defined as appropriate. The data transmission time interval is defined to be one hour corresponding to the above communication speed measurement time interval. Thus, the air conditioning data transmitted through a data transmission process described later is usable as data transmitted in the above communication speed measurement process in step S201 (FIG. 8). For example, the air conditioning data communication device 100 starts a transmission schedule creation process described below every hour on the hour.

First, the transmission schedule adjusting unit 114 acquires the volume limit of the air conditioning data in the current time slot (step S401). This limit is the smaller one of a first volume limit based on the monthly volume limit stored in the fee plan storage 122 and a second volume limit based on the communication speed in a time slot summed in the communication speed measurement process. In this example, the first volume limit is obtained by dividing the volume limit of the current month stored in the annual schedule storage 124 by the number of days of the month and the number of transmission times per day. For example, for the volume limit of the current month stored in the annual schedule storage 124 of 4 GB, the number of days of the month of 30, and the data transmission time interval of one hour, the first volume limit is 4 (GB/mo.)/30 (days/mo.)/24 (times/day) 5.556 MB. The first volume limit may be obtained by subtracting the consumed volume limit in the current month from the volume limit of the current month stored in the annual schedule storage 124 (remaining volume limit of the month), and then dividing the resultant difference by the number of remaining days of the month and the number of transmission times per day.

The second volume limit is a maximum data volume in the current time slot calculated from the communication speed corresponding to the current time slot and the workday/holiday information about the day summed in the communication speed measurement process. For example, the data transmission time interval is one hour, and the communication speed corresponding to the current time slot and the workday/holiday information about the day summed in the communication speed measurement process is 100 kbps (bit/s). Thus, the communication data volume transmittable within one hour in the current time slot is 100 (kbit/s)/8 (bits/byte)×60 (s/min)×60 (min/h)=4500 kB=4.5 MB. Thus, the smaller one of 5.556 MB and 4.5 MB, that is, 4.5 MB is set as the volume limit of the air conditioning data in the current time slot.

For the communication speed, the second volume limit larger than or equal to the communication data volume of all the data to be transmitted this time allows transmission of all the data in the current time slot. To allow all the data to be transmitted for the communication speed, the communication speed is to be higher than or equal to the data volume of all the data in the time slot divided by the time length of the time slot. The communication speed calculated from the data volume of all the data in the time slot divided by the time length of the time slot is referred to as a predetermined communication speed.

Subsequently, the transmission schedule adjusting unit 114 determines whether the air conditioning data stored in the air conditioning data storage 121 is all transmittable in the current time slot (step S402). This determines whether the communication data volume of all the air conditioning data to be currently transmitted is smaller than or equal to the volume limit acquired in step S401. For example, three air conditioners 300 are provided, the data acquisition time interval is set to one minute, and the data transmission time interval is set to one hour. In this example, data shown in FIG. 10 (e.g., 28 bytes as described above) used as the air conditioning data for each air conditioner 300 is to be transmitted for every data acquisition. In this example, 28 (byte/min per device)×3 (number of devices)×60 (min/h)×1 (h)=5040 bytes 5 kB is to be transmitted in the current time slot. If the volume limit acquired in step S401 is 4.5 MB, 5 kB<4.5 MB, and the air conditioning data is determined to be all transmittable in the current time slot.

When the transmission schedule adjusting unit 114 determines that the air conditioning data stored in the air conditioning data storage 121 is all transmittable in the current time slot (Yes in step S402), the transmission can be performed with no adjustment of the transmission schedule. Thus, the transmission schedule creation process ends.

When determining that the air conditioning data stored in the air conditioning data storage 121 is not all transmittable in the current time slot (No in step S402), the transmission schedule adjusting unit 114 determines whether the currently remaining data and data to be transmitted in the next time slot are both transmittable in the next time slot (step S403). The data to be transmitted in the next time slot is unknown at this point, and thus the maximum data volume is used for the determination.

For example, only 3.5 kB of all the communication data volume of 4.5 kB is transmittable in the current time slot under the communication speed, and 1 kB of the communication data volume is left untransmitted. The maximum data volume for the next time slot is assumed to be 4.5 kB. The transmission schedule adjusting unit 114 then determines whether 5.5 kB obtained from 1 kB+4.5 kB is transmittable in the next time slot.

The transmission schedule adjusting unit 114 then calculates the volume limit transmittable in the next time slot in the same manner as in step S401. For example, the first volume limit for the next time slot is about 5.556 MB, and the second volume limit is 10 kB. In this example, the volume limit for the next time slot is 10 kB. This is larger than 5.5 kB, which is the total data volume of the currently remaining data and the data to be transmitted in the next time slot. In the above example, the transmission schedule adjusting unit 114 determines that the currently remaining data and the data to be transmitted in the next time slot are both transmittable in the next time slot.

When determining that the currently remaining data and the data to be transmitted in the next time slot are both transmittable in the next time slot (Yes in step S403), the transmission schedule adjusting unit 114 adjusts the schedule to transmit the currently remaining data together with the data to be transmitted in the next time slot (step S404), and ends the transmission schedule creation process.

When determining that the currently remaining data and/or the data to be transmitted in the next time slot are not transmittable in the next time slot (No in step S403), the transmission schedule adjusting unit 114 determines whether any of the air conditioners 300 is turned off in the current time slot (step S405). This is determined by determining whether the air conditioning data storage 121 stores the air conditioning data about the air conditioner 300 that is in a non-operation state. When the transmission schedule adjusting unit 114 determines that no air conditioner 300 is turned off in the current time slot (No in step S405), the processing advances to step S408.

When determining that any air conditioner 300 is turned off in the current time slot (Yes in step S405), the transmission schedule adjusting unit 114 adjusts the transmission schedule not to transmit the air conditioning data about the air conditioner 300 that is turned off (step S406). For example, the transmission schedule adjusting unit 114 deletes the air conditioning data about the air conditioner 300 in a non-operation state from the air conditioning data storage 121 to avoid transmitting the air conditioning data about the air conditioner 300 that is turned off.

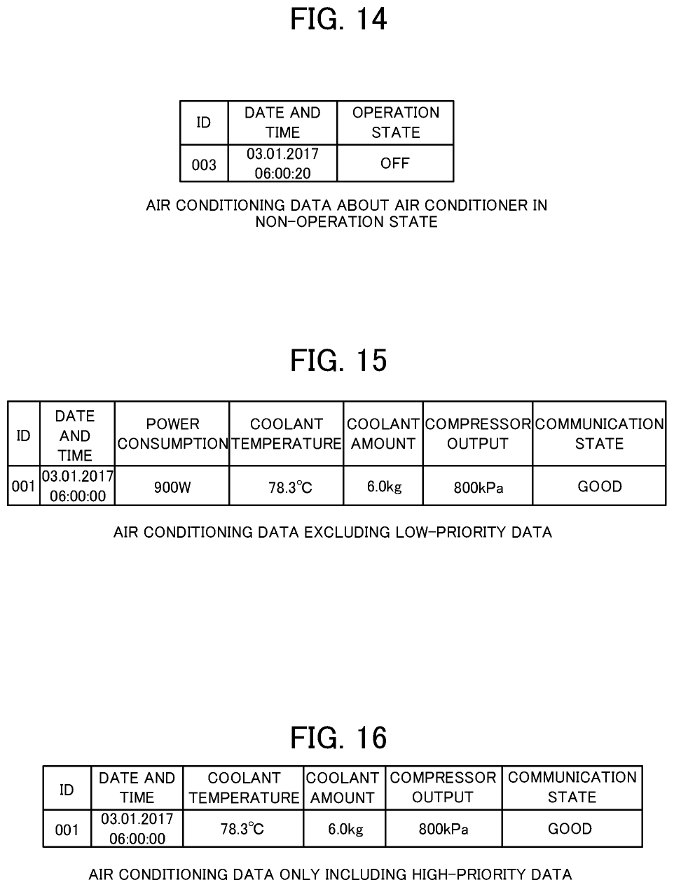

After avoiding transmitting the air conditioning data about the air conditioner 300 that is turned off, the transmission schedule adjusting unit 114 determines whether the air conditioning data stored in the air conditioning data storage 121 is all transmittable in the current time slot (step S407). As shown in FIG. 14, the air conditioning data about the air conditioner 300 that is turned off includes the ID, the date and time, and the operation state of the air conditioner 300. For example, the communication data volume per communication is 2+6+1=9 bytes, in which the ID has 2 bytes, the date and time has 6 bytes, and the operation state has 1 byte. After deleting the air conditioning data corresponding to the communication data volume of 9 bytes for each air conditioner 300 that is turned off in step S406, the transmission schedule adjusting unit 114 determines whether the currently transmitted data volume is smaller than or equal to the volume limit in step S407.

When determining that the air conditioning data stored in the air conditioning data storage 121 is all transmittable in the current time slot by avoiding transmitting the air conditioning data about the air conditioner 300 that is turned off (Yes in step S407), the transmission schedule adjusting unit 114 ends the transmission schedule creation process.

When determining that the air conditioning data stored in the air conditioning data storage 121 is not all transmittable in the current time slot independently of avoiding transmitting the air conditioning data about the air conditioner 300 that is turned off (No in step S407), the transmission schedule adjusting unit 114 reduces the transmission data based on the priority of the air conditioning data to adjust the schedule (step S408). In this process, the priority data determination unit 113 determines the priority of the data stored in the air conditioning data storage 121, and the transmission schedule adjusting unit 114 excludes the low-priority data from the transmission data. The transmission schedule adjusting unit 114 determines whether the air conditioning data stored in the air conditioning data storage 121 is all transmittable in the current time slot after excluding the low-priority data from the transmission data (step S409).

Steps S408 and S409 will now be described specifically. First, in step S408, the priority data determination unit 113 deletes the low-priority data from the data stored in the air conditioning data storage 121. Thus, as shown in FIG. 15, the communication data volume is reduced from, for example, the air conditioning data shown in FIG. 10. In the above example, the communication data volume for the air conditioning data shown in FIG. 10 has 28 bytes. Based on the calculation under the same conditions, the communication data volume of the air conditioning data shown in FIG. 15 is 2+6+2×4+1=17 bytes. Thus, a data volume of 11 bytes is reduced per communication.

The transmission schedule adjusting unit 114 then determines whether the current transmission data volume is smaller than or equal to the volume limit in step S409. Data may have multiple priority levels. In the present embodiment, for example, the priority data determination unit 113 classifies data into three priority levels, or a high priority, an intermediate priority, and a low priority. First, the transmission schedule adjusting unit 114 determines whether the communication data volume of the transmission data excluding the low-priority air conditioning data is smaller than or equal to the volume limit in step S409. When the determination result is negative, the processing returns to step S408, in which the priority data determination unit 113 also excludes the intermediate-priority air conditioning data. As shown in FIG. 16, for example, the communication data volume is then reduced from the air conditioning data shown in FIG. 10. In the above example, the communication data volume for the air conditioning data shown in FIG. 10 has 28 bytes. Based on the calculation under the same condition, the communication data volume for the air conditioning data shown in FIG. 16 is 2+6+2×3+1=15 bytes, and the communication data volume of 13 bytes is reduced per communication. For data having multiple priority levels, the priority data determination unit 113 excludes data in order from low-priority to higher-priority data until the current transmission data volume reaches or falls within the volume limit or until only the highest-priority data is included.

When determining that the air conditioning data stored in the air conditioning data storage 121 excluding the low-priority data is all transmittable in the current time slot (Yes in step S409), the transmission schedule adjusting unit 114 ends the transmission schedule creation process.

When determining that the air conditioning data stored in the air conditioning data storage 121 excluding the low-priority data is not all transmittable in the current time slot (No in step S409), the transmission schedule adjusting unit 114 adjusts the schedule with data thinning (step S410). More specifically, for example, the current transmission data volume is 3 kB without the transmission schedule adjusting unit 114 transmitting the air conditioning data about the air conditioner 300 that is turned off and the low-priority and intermediate-priority air conditioning data, and the current volume limit is 1 kB. In this example, 3 kB/1 kB=3, and the transmission schedule adjusting unit 114 thins data into one third of the communication data volume of the transmission data. For an indivisible division, the communication data volume is thinned into one n-th, where n is obtained by rounding up the fractional portions.

The transmission schedule creation process then ends. Through the above transmission schedule creation process, a transmission schedule is created to enable transmission of a data volume transmittable within the current transmission time slot.

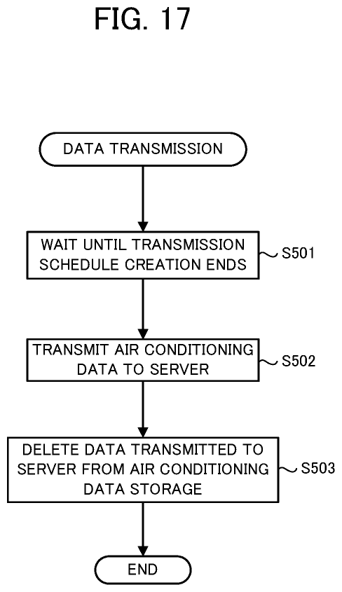

A data transmission process in which the air conditioning data communication device 100 transmits the air conditioning data stored in the air conditioning data storage 121 to the server 200 will now be described with reference to FIG. 17. The process is started at time intervals for data transmission. The data transmission time interval is set to one hour corresponding to the above communication speed measurement time interval. For example, the air conditioning data communication device 100 starts the data transmission process described below every hour on the hour.

First, the data transmission unit 115 waits until the transmission schedule adjusting unit 114 ends the transmission schedule creation process (step S501). When the transmission schedule creation process ends, the data transmission unit 115 transmits the air conditioning data stored in the air conditioning data storage 121 to the server 200 through the long-distance communication unit 132 in accordance with the created transmission schedule (step 502). Step S502 is also referred to as a data transmission step. The data transmission unit 115 deletes the air conditioning data transmitted to the server 200 from the air conditioning data storage 121 (step S503), and ends the data transmission process.

As described above, the air conditioning data communication device 100 performs the transmission schedule creation process and the data transmission process in parallel in separate threads. Instead of performing the data transmission process in parallel with the transmission schedule creation process in separate threads, the air conditioning data communication device 100 may perform the data transmission process after the transmission schedule creation process ends. In this example, step S501 may be eliminated.

The air conditioning data communication device 100 according to Embodiment 1 described above can implement cost-effective data communications for one year with the annual transmission schedule created by the transmission schedule adjusting unit 114 based on the fee plan information.

Modification 1

The priority data determination unit 113 according to Embodiment 1 determines the coolant temperature, the coolant amount, the compressor pressure, and the communication state that are data associated with malfunctions to be high-priority data among the air conditioning data. When such data includes abnormal data, the air conditioner 300 is highly likely to have malfunctions. However, the priority data determination unit 113 may successfully determine malfunctions of the air conditioner 300 although data at the boundary between abnormal and normal ranges or data within the abnormal range is transmitted and data reliably falling within the normal range is not transmitted. In Modification 1 described below, the priority data determination unit 113 more precisely determines data associated with malfunctions.

An air conditioning data communication device 100 according to Modification 1 is the same as the air conditioning data communication device 100 according to Embodiment 1 except for the priority data determination unit 113. The priority data determination unit 113 according to Modification 1 determines the coolant temperature, the coolant amount, the compressor pressure, and the communication state to be high-priority data when any of these items from the air conditioning data deviates from the normal range. The priority data determination unit 113 determines the coolant temperature, the coolant amount, the compressor pressure, and the communication state to be low-priority data when all of these items fall within the normal range.

The priority data determination unit 113 according to Modification 1 operates in the same manner as the priority data determination unit 113 according to Embodiment 1 in that the priority data determination unit 113 determines data representing the power consumption of the air conditioner 300 to be intermediate-priority data selectively from other items of air conditioning data. The air conditioning data communication device 100 according to Modification 1 is the same as the air conditioning data communication device 100 according to Embodiment 1 except for the above feature.

In the air conditioning data communication device 100 according to Modification 1 described above, the priority data determination unit 113 more precisely determines data associated with malfunctions. Thus, a larger amount of transmission data is reduced in the transmission schedule creation process in step S408 (FIG. 13) than in Embodiment 1. This reduces the amount of data thinned in step S410 to more effectively implement cost-effective data communications.

Modification 2

The priority data determination unit 113 according to Embodiment 1 determines the coolant temperature, the coolant amount, the compressor pressure, and the communication state that are data associated with malfunctions to be high-priority data among the air conditioning data. When such data includes abnormal data, the air conditioner 300 is highly likely to have malfunctions. However, independently of whether such data items fall within a normal range, the air conditioner 300 may have malfunctions based on the relationship between the temperature setting and the room temperature. In Modification 2 described above, a priority data determination unit 113 determines data associated with malfunctions more flexibly.

The air conditioning data communication device 100 according to Modification 2 is the same as the air conditioning data communication device 100 according to Embodiment 1 except for the priority data determination unit 113. The priority data determination unit 113 in the air conditioning data communication device 100 according to Modification 2 determines the operation mode, the temperature setting, the room temperature, the room humidity, and the outside temperature among the air conditioning data to be high-priority data when the data includes signs of malfunctions based on the operation mode, the temperature setting, and the room temperature. For example, the data includes signs of malfunctions when the difference between the room temperature and the temperature setting does not fall below the reference temperature difference as the operation continues for the reference time. The reference time and the reference temperature difference may be determined to have appropriate values. In this example, the reference time is determined to be one hour, and the reference temperature difference is determined to be 5° C.

When, for example, the room temperature falls within a certain range (for example, within less than 5° C.) from the temperature setting, the data is determined to be low-priority data. When, for example, the room temperature remains more than or equal to 5° C. lower or higher than the temperature setting without rising or falling after the heating or cooling operation for one hour, the priority data determination unit 113 determines the operation mode, the temperature setting, the room temperature, the room humidity, and the outside temperature to be high-priority data. When the difference between the room temperature and the temperature setting falls within 5° C., the priority data determination unit 113 determines the operation mode, the temperature setting, the room temperature, the room humidity, and the outside temperature to be low-priority data.

The priority data determination unit 113 according to Modification 2 operates in the same manner as the priority data determination unit 113 according to Embodiment 1 in that the priority data determination unit 113 determines the coolant temperature, the coolant amount, the compressor pressure, and the communication state to be high-priority data among the air conditioning data, and determines the data representing power consumption of the air conditioner 300 to be intermediate-priority data. The air conditioning data communication device 100 according to Modification 2 is the same as the air conditioning data communication device 100 according to Embodiment 1 except for the above feature.

In the air conditioning data communication device 100 according to Modification 2 described above, the priority data determination unit 113 more flexibly determines data to be associated with malfunctions. When the cooling or heating operation has a poor effect without any abnormality in the coolant temperature, the coolant amount, the compressor output, and the communication state, the priority data determination unit 113 leaves the operation mode, the temperature setting, the room temperature, the room humidity, and the outside temperature at that time as the high-priority data without deleting the data in the transmission schedule creation process in step S408 (FIG. 13). Thus, the air conditioning data communication device 100 according to Modification 2 can transmit data for analyzing the poor cooling or heating effect to the server 200.

Modification 3

The annual schedule adjustment process according to Embodiment 1 (FIG. 11) allocates the communication volume to maximize the carryover volume allowance for the month even slightly exceeding the volume limit of the subscribed fee plan. This maximizes the air conditioning data transmitted in summer and winter. When, for example, the volume limit of the subscribed fee plan is 3 GB, and the carryover volume allowance is 3 GB, the volume limit in summer and winter is 4 GB. In this example, if the maximum volume per month is 3.5 GB, 0.5 GB of the carryover volume allowance of 1 GB is left unconsumed although the data is reduced by the volume of 1 GB in spring and fall. In response to this, in Modification 3, the transmission schedule adjusting unit 114 finely adjusts carryover volumes in accordance with the maximum data volume per month in the annual schedule adjustment process.

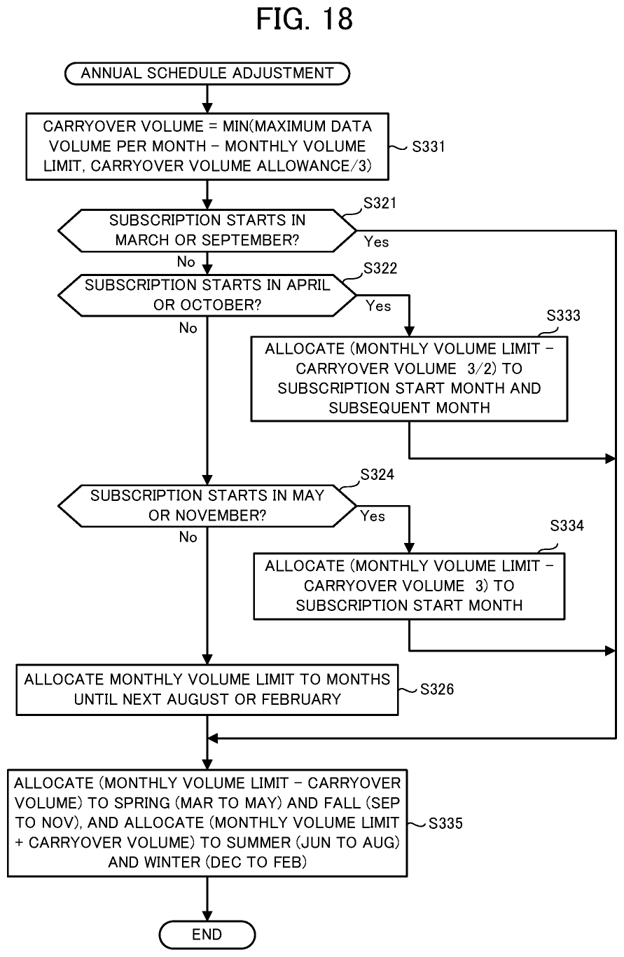

The air conditioning data communication device 100 according to Modification 3 is the same as the air conditioning data communication device 100 according to Embodiment 1 except for the annual schedule adjustment process. The annual schedule adjustment process according to Modification 3 will now be described with reference to FIG. 18. The annual schedule adjustment process according to Modification 3 (FIG. 18) is mostly similar to the annual schedule adjustment process according to Embodiment 1 (FIG. 11). Thus, the same steps are denoted by the same numerals, and the different features will be described mainly.

First, the transmission schedule adjusting unit 114 according to Modification 3 substitutes, to a variable carrying a carryover, the smaller one of the difference obtained by subtracting the monthly volume limit of the fee plan from the maximum data volume per month and the value obtained by dividing the carryover volume allowance of the fee plan by 3 (step S331). The transmission schedule adjusting unit 114 may use the value obtained in the annual schedule creation process in step S303 (FIG. 9) as the maximum data volume per month.

The determination processes in steps S321, S322, and S324 and the process in step S326 are the same as the corresponding processes in FIG. 11, and will not be described. When the determination result in step S322 is positive (Yes in step S322), the transmission schedule adjusting unit 114 allocates the volume obtained by subtracting the variable carrying the carryover from the monthly volume limit and multiplying the difference by 3/2 as the volume limit of the subscription start month and the subsequent month (step S333), and the processing advances to step S335.

When the determination result in step S324 is positive (Yes in step S324), the transmission schedule adjusting unit 114 allocates the volume obtained by subtracting the variable carrying the carryover from the monthly volume limit and multiplying the difference by 3 as the volume limit of the subscription start month (step S334), and the processing advances to step S335.

In step S335, the transmission schedule adjusting unit 114 allocates the volume obtained by subtracting the variable carrying carryover from the monthly volume limit of the fee plan stored in the fee plan storage 122 as the volume limit for spring (March to May) and fall (September to November), and allocates the volume obtained by adding the variable carrying carryover to the monthly volume limit as the volume limit for summer (June to August) and winter (December to February), and ends the annual schedule adjustment process.

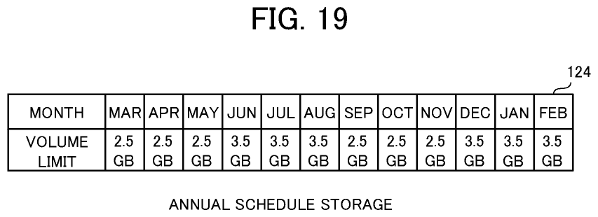

The air conditioning data communication device 100 according to Modification 3 described above finely adjusts the volume to be carried over by the transmission schedule adjusting unit 114 from the low operational period to the high operational period reflecting the maximum data volume per month. Thus, the carryover volume can be more efficiently used. When, for example, the subscribed fee plan is the plan shown in FIG. 4, the maximum data volume per month is 3.5 GB, and the subscription start month is March, the annual schedule storage 124 stores data shown in FIG. 19 through the annual schedule adjustment process.

### Embodiment 2

The transmission schedule creation process according to Embodiment 1 (FIG. 13) is started at time intervals defined for data transmission. Through this process, a transmission schedule is created for the air conditioning data transmitted in that time slot. In this process, the volume limit of the air conditioning data in that time slot is acquired in step S401. The volume limit acquired at this time is the average of the volume usable in the entire month. Thus, the volume cannot be increased or reduced for use in only a specific period of the month. However, in some situations, the volume may be intended to be increased in the first half of the month more than in the second half. To increase or decrease the volume between the days of the same month, a transmission schedule is created within a month in advance in Embodiment 2 described below.

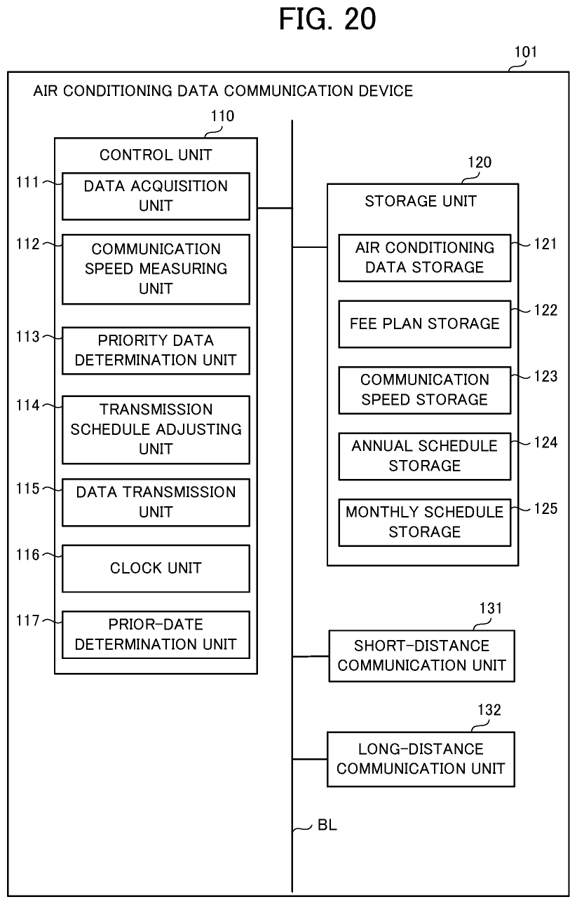

As shown in FIG. 20, an air conditioning data communication device 101 according to Embodiment 2 differs from the air conditioning data communication device 100 according to Embodiment 1 in that the air conditioning data communication device 101 includes a priority-date determination unit 117 and a monthly schedule storage 125. The transmission schedule adjusting unit 114 according to Embodiment 2 performs a monthly schedule creation process (described later) instead of the transmission schedule creation process (FIG. 13). In addition, a data transmission process according to Embodiment 2 differs from the data transmission process according to Embodiment 1 in that the data transmission unit 115 refers to the monthly schedule created by the transmission schedule adjusting unit 114. These different features will be described one after another.

The priority-date determination unit 117 determines data acquisition days for which data is to be transmitted with priority when the air conditioning data acquired by the data acquisition unit 111 is not all transmittable to the server 200. The priority-date determination unit 117 specifically determines the days to the vernal equinox in March and days to the autumnal equinox in September to be high-priority data acquisition days. March in spring and September in fall are both in a low operational period, and usually have a smaller volume limit stored in the annual schedule storage 124 than the monthly volume limit originally set in the fee plan. Usually, however, heating is used until the vernal equinox day, and cooling is used until the autumnal equinox day. To increase the volume limit allocated to these days, the priority-date determination unit 117 raises the priority of data acquired by the data acquisition unit 111 on these days. The priority-date determination unit 117 functions as priority-date determination means.

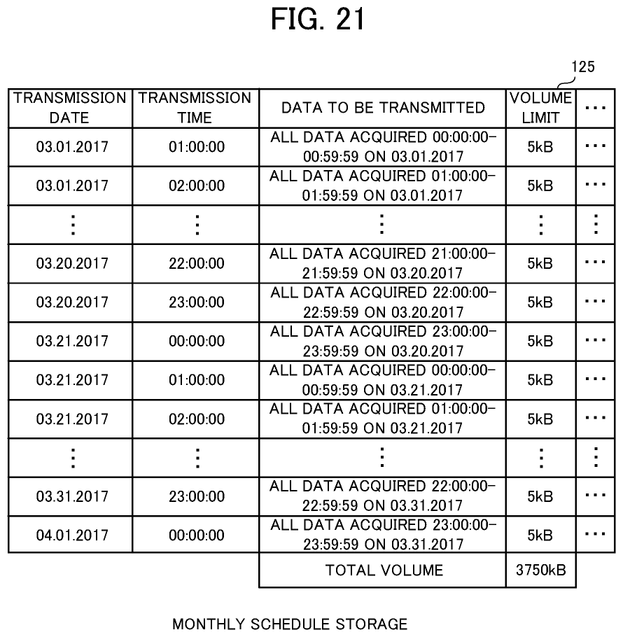

The monthly schedule storage 125 stores a monthly transmission schedule (monthly schedule) created by the transmission schedule adjusting unit 114 in a monthly schedule creation process described below. More specifically, as shown in FIG. 21, the monthly schedule storage 125 stores the transmission date, the transmission time, the data to be transmitted, and the volume limit allocated to the time slot. FIG. 21 shows an example of a monthly schedule for transmitting, every hour on the hour, all the air conditioning data of 5 kB stored in the air conditioning data storage 121 within the preceding one hour. The monthly schedule storage 125 functions as monthly schedule storage means.

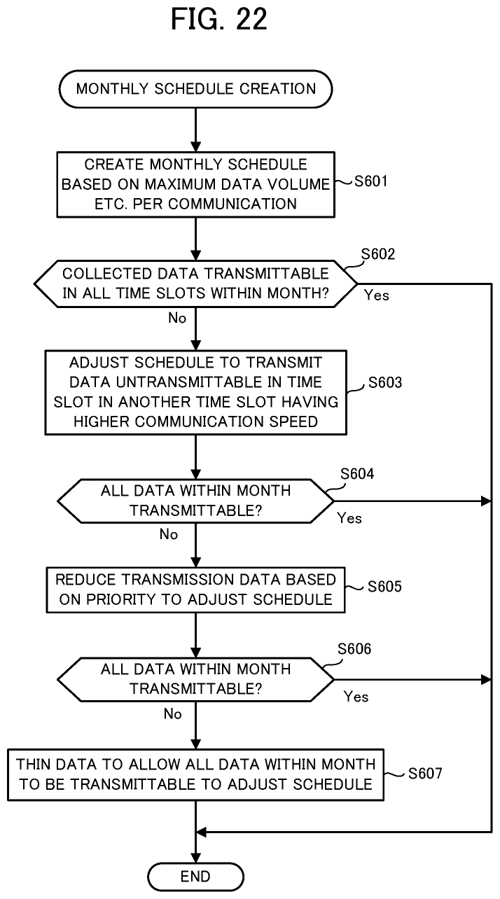

A monthly schedule creation process in which the air conditioning data communication device 101 creates a monthly schedule will now be described with reference to FIG. 22. The process is performed at the beginning of every month. The monthly schedule creation process is preceded by creating the annual transmission schedule, and is thus usually started after the annual schedule creation process is complete.

First, the transmission schedule adjusting unit 114 creates a monthly schedule based on the maximum data volume of the air conditioning data per communication, the number of air conditioners 300, the data acquisition time interval, and the data transmission time interval, and stores the monthly schedule into the monthly schedule storage 125 (step S601). In this example, the data transmission time intervals are the time intervals at which the air conditioning data is transmitted to the server 200 through the above data transmission process. The transmission schedule adjusting unit 114 may use the value acquired in the annual schedule creation process (FIG. 9) in step S302 as the maximum data volume of the air conditioning data per communication. For example, the maximum data volume per communication is 28 bytes, the number of air conditioners 300 is three, the data acquisition time interval is one minute, and the data transmission time interval is one hour. In this example, the maximum data volume transmitted in one data transmission is 28 (byte/min per device)×3 (number of devices)×60 (min/h)×1 (h)=5040 bytes 5 kB. Thus, a monthly schedule shown in FIG. 21 is created.

Subsequently, the transmission schedule adjusting unit 114 determines whether the air conditioning data in all the time slots in the monthly schedule created in step S601 is all transmittable (step S602). Whether the data is transmittable is determined based on the two parameters, or the communication speed and the volume limit. When the data is determined transmittable based on the two parameters, the air conditioning data is determined all transmittable in all the time slots.

For the communication speed, the transmission schedule adjusting unit 114 determines whether the data for the volume limit is transmittable within a time length in the time slots of each day in the monthly schedule at the communication speed for the time slot summed through the communication speed measurement process. For the volume limit, the transmission schedule adjusting unit 114 determines whether the total volume, or the sum of the volume limit of all days and all time slots as a maximum monthly transmission data volume, is smaller than or equal to the volume limit of the month stored in the annual schedule storage 124.

Among the communication speeds summed through the communication speed measurement process, the communication speed corresponding to a specific time slot is 100 kbps. In this example, the communication data volume transmittable within one hour in the time slot is 100 (kbit/s)/8 (bit/byte)×60 (s/min)×60 (min/h)=4500 kB=4.5 MB. For example, in the monthly schedule shown in FIG. 21, the volume limit per hour for all the time slots is 5 kB, and smaller than 4.5 MB. In this example, for the communication speed, the air conditioning data is determined to be all transmittable in all the time slots in a monthly schedule.

The total volume is 3750 kB in the example shown in FIG. 21, whereas the volume limit of this month (March) is 2 GB in the example shown in FIG. 12. With the total volume of 3750 kB smaller than the volume limit of 2 GB, the air conditioning data is determined to be all transmittable in all the time slots in a monthly schedule. In this example, the air conditioning data is determined to be all transmittable based on both the communication speed and the volume limit. Thus, the air conditioning data is determined to be all transmittable in all the time slots in a monthly schedule also in the final determination.

Among the communication speeds summed through the communication speed measurement process, the communication speed corresponding to a specific time slot is 100 bps (bit/s). In this example, the communication data volume transmittable within one hour in the time slot is 100 (bit/s)/8 (bit/byte)×60 (s/min)×60 (min/h)=4500 bytes=4.5 kB. Thus, the data of 5 kB of the volume limit is not all transmittable in the time slot. For the communication speed, the data is determined not to be all transmittable, and the air conditioning data is determined not to be all transmittable in all the time slots in a monthly schedule also in the final determination.

When the air conditioning data is determined to be all transmittable in all the time slots in a monthly schedule (Yes in step S602), the monthly schedule creation process ends. When the air conditioning data is determined not to be all transmittable in all the time slots in a monthly schedule (No in step S602), the transmission schedule adjusting unit 114 adjusts the monthly schedule for the data untransmittable in a time slot to be transmitted in the time slot having a high communication speed (step S603). In this adjustment, the transmission schedule adjusting unit 114 may adjust the monthly schedule by shifting part of the air conditioning data untransmittable in the time slot to the next time slot or to a later time slot having a higher communication speed.

For example, the communication speed in the 12:00-13:00 time slot on workdays is 100 bps, and the communication speed in 13:00-14:00 time slot on workdays is 200 bps. In this example, the transmission schedule adjusting unit 114 changes the volume of communication data to be transmitted at 12:00:00 on workdays from all the data acquired between 11:00:00 and 11:59:59 to all the data acquired between 11:00:00 and 11:29:59, and changes the volume of communication data to be transmitted at 13:00:00 on workdays from all the data acquired between 12:00:00 and 12:59:59 to all the data acquired between 11:30:00 and 12:59:59. The transmission schedule adjusting unit 114 thus adjusts the monthly schedule to prevent a failure in transmitting part of the air conditioning data under the communication speed.

The transmission schedule adjusting unit 114 then determines whether the schedule adjustment in step S603 enables transmission of all the transmission data within a month (step S604). As in the determination in step S602, the transmission schedule adjusting unit 114 determines that the transmission data within a month is all transmittable when the data is transmittable in the time slots of each day in the monthly schedule based on both the communication speed and the volume limit.

When the transmission data within a month is all transmittable (Yes in step S604), the monthly schedule creation process ends. When the transmission data within a month is not all transmittable (No in step S604), the transmission schedule adjusting unit 114 reduces the transmission data based on the priority of the air conditioning data to adjust the schedule (step S605). In this process, the priority data determination unit 113 and the priority-date determination unit 117 determine the priority of the air conditioning data stored in the air conditioning data storage 121, and the transmission schedule adjusting unit 114 excludes the low-priority data from the transmission data.

In this example, the priority may be determined to be appropriate by combining the priorities determined by the priority data determination unit 113 and the priority-date determination unit 117. For example, the air conditioning data about the date determined to have a high priority by the priority-date determination unit 117 may be left without being excluded from the transmission data independently of the priority determined by the priority data determination unit 113. In addition, the air conditioning data about the date determined not to have a high priority by the priority-date determination unit 117 and the air conditioning data determined to have a low priority by the priority data determination unit 113 may be excluded from the transmission data.

In the actual monthly schedule creation process, the air conditioning data about the month has not yet been stored in the air conditioning data storage 121. However, for example, the transmission schedule adjusting unit 114 changes the volume of transmission data for the time slot having a low communication speed from all the data to the data excluding low-priority data as the monthly schedule. In the above example, when the transmission data corresponds to all the data, the maximum data volume transmitted in one data transmission is 28 (byte/min per device)×3 (number of devices)×60 (min/h)×1 (h/day)=5040 bytes 5 kB. In this example, when the volume of transmission data is changed from all the data to the data excluding low-priority data, the communication data volume for one transmission data is reduced from 28 bytes to 17 bytes. Thus, the maximum data volume in one data transmission is reduced to 17 (byte/min per device)×3 (number of devices)×60 (min/h)×1 (h)=3060 bytes 3 kB.

After excluding the low-priority data from the transmission data, the transmission schedule adjusting unit 114 determines whether the transmission data within a month is all transmittable (step S606). As in Embodiment 1, in steps S605 and S606, when data can have multiple priority levels, the transmission schedule adjusting unit 114 increments the priority level of the data to be excluded from the transmission data by one level each until the total volume for a month falls within the volume limit of the month or until only the highest-priority data is included.

When the transmission schedule adjusting unit 114 determines that the transmission data within a month excluding the low-priority data is all transmittable (Yes in step S606), the monthly schedule creation process ends.

When the transmission schedule adjusting unit 114 determines that the transmission data within a month excluding the low-priority data is not all transmittable (No in step S606), the transmission schedule adjusting unit 114 adjusts the schedule by thinning data to transmit all the data within a month (step S607). Data thinning may be performed as appropriate. For example, the transmission schedule adjusting unit 114 may thin data into one n-th of the communication data volume, where n denotes the value obtained by rounding up fractional portions of the amount obtained by dividing the transmission data volume within a month by the volume limit of the month. When the data within the month is all transmittable by thinning data about the date determined not to have a high-priority by the priority-date determination unit 117, the transmission schedule adjusting unit 114 may not thin data about the date determined to have a high-priority by the priority-date determination unit 117.

After the transmission schedule adjusting unit 114 adjusts the schedule to transmit all the data within a month in step S607, the monthly schedule creation process ends.

A monthly schedule shown in FIG. 21 is created in step S601, and the volume limit of the month is 3000 kB under the communication speed with no difficulties in each time slot In this example, in step S605, the priority data determination unit 113 and the priority-date determination unit 117 determine the priority of the air conditioning data, and the transmission schedule adjusting unit 114 adjusts the monthly schedule.

For example, the air conditioning data on and after March 21 is determined not to have a high priority by the priority-date determination unit 117, and thus to be excluded. The transmission schedule adjusting unit 114 thus adjusts the monthly schedule to transmit only the air conditioning data determined to have a high priority by the priority data determination unit 113. For example, the air conditioning data determined to have a high priority by the priority data determination unit 113 is data with a data volume of 15 bytes shown in FIG. 16. The communication data volume for March is 28 (byte/min per device)×3 (number of devices)×60 (min/h)×24 (h/day)×20 (days)+15 (byte/min per device)×3 (number of devices)×60 (min/h)×24 (h/day)×11 (days)=3132000 bytes=3132 kB, slightly exceeding the volume limit of the month of 3000 kB.

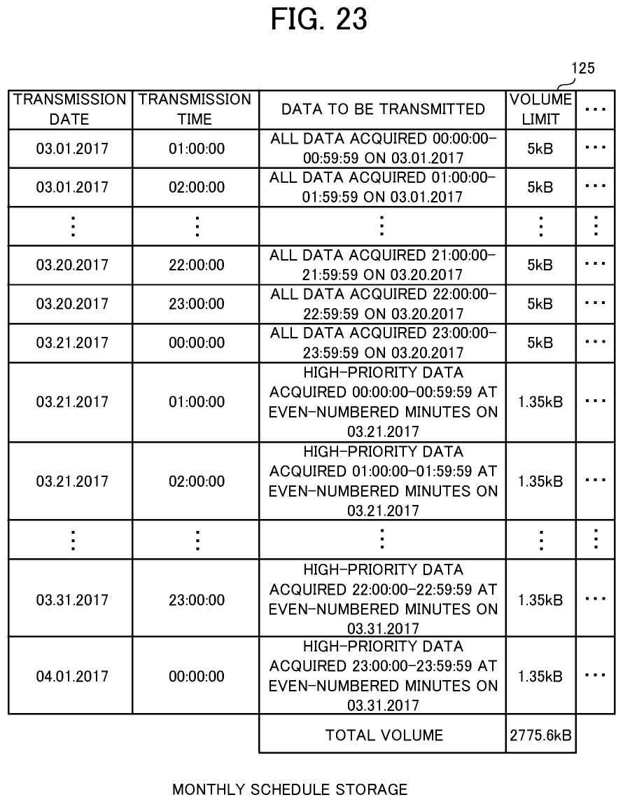

In step S607, the transmission schedule adjusting unit 114 thins, into half, the air conditioning data about a date determined not to have a high priority by the priority-date determination unit 117. For example, the transmission schedule adjusting unit 114 adjusts the monthly schedule to transmit only the air conditioning data at the even-numbered minutes of every hour, such as 0, 2, or 4. Thus, the communication data volume of March is 28 (byte/min per device)×3 (number of devices)×60 (min/h)×24 (h/day)×20 (days)+7.5 (byte/min per device)×3 (number of devices)×60 (min/h)×24 (h/day)×11 (days)=2775600 bytes=2775.6 kB, which falls below the volume limit of the month of 3000 kB. Thus, the monthly schedule shown in FIG. 23 is created.

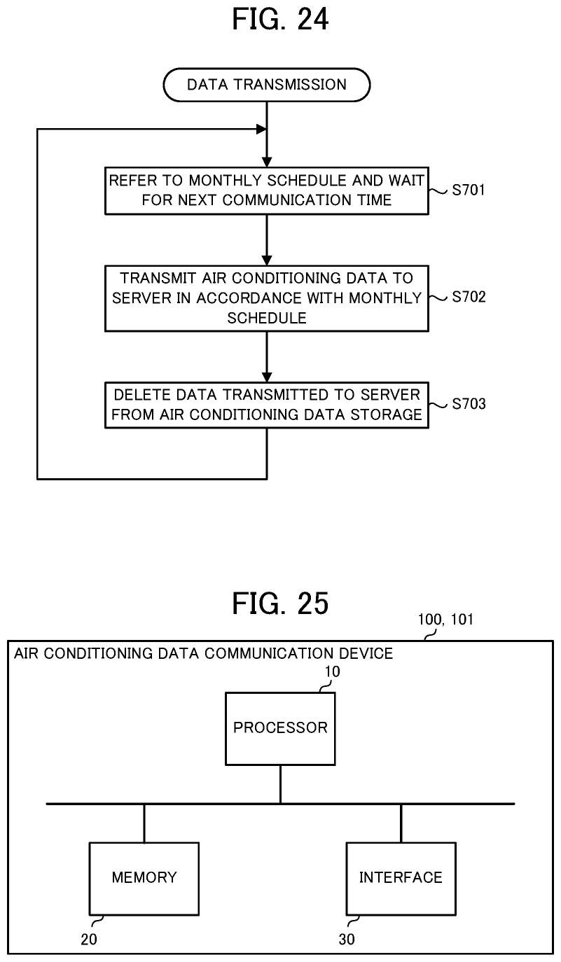

A data transmission process in which the air conditioning data communication device 101 transmits the air conditioning data stored in the air conditioning data storage 121 to the server 200 will now be described with reference to FIG. 24. When the transmission schedule adjusting unit 114 creates a monthly schedule in the monthly schedule storage 125, the data transmission process is started.

First, the data transmission unit 115 in the air conditioning data communication device 101 refers to the monthly schedule stored in the monthly schedule storage 125, and wait for the next communication time (step S701). At the next communication time, the data transmission unit 115 transmits the air conditioning data stored in the air conditioning data storage 121 to the server 200 through the long-distance communication unit 132 in accordance with the referred monthly schedule (step 702). The data transmission unit 115 then deletes the air conditioning data transmitted to the server 200 from the air conditioning data storage 121 (step S703), and the processing returns to step S701.

The air conditioning data communication device 101 according to Embodiment 2 described above creates a monthly schedule to enable flexible setting of periods in a month with an increased or reduced volume. Thus, the cost-effective data communications are achieved within a month.

Modifications

The air conditioning data communication device 101 according to Embodiment 2 adjusts a transmission schedule in a monthly schedule creation process in step S607 (FIG. 22) in which the transmission schedule adjusting unit 114 thins data to transmit all the data within a month. However, the transmission schedule adjusting unit 114 may adjust the transmission schedule to carry over the air conditioning data left untransmitted within the month to the next month without thinning the data. A modification of Embodiment 2 will be described.

A transmission schedule adjusting unit 114 according to the modification records, into the monthly schedule storage 125, a schedule for postponing transmission of the air conditioning data left untransmitted within the current month to the next month without thinning data in the monthly schedule creation process in step S607 (FIG. 22). When creating the monthly schedule for the next month, the transmission schedule adjusting unit 114 creates a monthly schedule in step S601 using the schedule of transmitting the postponed data recorded in the previous month. Except for the above feature, the air conditioning data communication device 101 according to the modification is the same as the air conditioning data communication device 101 according to Embodiment 2.

The air conditioning data communication device 101 according to the modification does not thin data, and allows the server 200 to acquire all the air conditioning data about the air conditioner 300.

The embodiments described above may be combined as appropriate. For example, Modifications 1 and 2 of Embodiment 1 may be combined to achieve more cost-effective communications of data associated with malfunctions. Embodiments 1 and 2 may be combined to perform the transmission schedule creation process and the data transmission process according to Embodiment 1 instead of the data transmission process according to Embodiment 2 with reference to the monthly schedule to achieve the advantageous effects produced by both Embodiments 1 and 2.

In the above embodiments, the billing cycle is based on a month. The annual schedule creation process is thus performed every month to create an annual schedule including volume limits allocated to each month. The billing cycle is not limited to a month. For a billing cycle based on, for example, a day, a week, or two months, the annual schedule creation process is performed for each billing cycle to create an annual schedule including volume limits allocated to each billing cycle. For a billing cycle other than a monthly billing cycle, the schedule creation process according to Embodiment 2 is changed from per month to per billing cycle. The schedule creation process for each billing cycle is performed per billing cycle to create a schedule for each billing cycle including volume limits allocated to each time slot in the billing cycle.

In the above embodiments, the data acquisition unit 111 acquires air conditioning data through the short-distance communication unit 131, but may acquire the air conditioning data with other methods. For example, each air conditioner 300 may include an air conditioning data communication device 100 to allow the data acquisition unit 111 to acquire the air conditioning data about each air conditioner 300 with a bus line BL.

As shown in, for example, FIG. 25, the hardware of each of the air conditioning data communication devices 100 and 101 according to the embodiments of the present disclosure includes a processor 10, a memory 20, and an interface 30. The functions of the air conditioning data communication device 100 or 101 are implemented by the processor 10 executing programs stored in the memory 20. The interface 30 allows the air conditioning data communication device 100 or 101 to be connected to another air conditioning data communication device 100 or 101 to establish communications, and may include a variety of interfaces as appropriate. FIG. 25 shows an example including a single processor 10 and a single memory 20. However, multiple processors and multiple memories may be used in cooperation to implement the functions.

In any of the above embodiments, the functions may be implemented by a normal computer. In detail, in the embodiments described above, the programs executed by the control unit 110 are stored in advance in the storage unit 120. However, the programs may be stored in a computer-readable recording medium, such as a flexible disk, a compact disc read only memory (CD-ROM), a digital versatile disc (DVD), and a magneto-optical (MO) disk, distributed, and read to be installed by a computer that can implement the above functions. To implement the functions by sharing between an operating system (OS) and an application or with an OS and an application in cooperation, the programs to be partly implemented by portions other than the OS may be stored in a recording medium.

Further, programs may be superimposed on a carrier wave to be distributed with a communication network. For example, programs may be posted on a bulletin board system (BBS) on a communication network to be distributed with a network. These programs may be activated and executed under the control of the OS similarly with other application programs to execute the above processing.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

10 Processor
20 Memory
30 Interface
100, 101 Air conditioning data communication device
110 Controller
111 Data acquisition unit
112 Communication speed measuring unit
113 Priority data determination unit
114 Transmission schedule adjusting unit
115 Data transmission unit
116 Clock unit
117 Priority-date determination unit
120 Storage
121 Air conditioning data storage
122 Fee plan storage
123 Communication speed storage
124 Annual schedule storage
125 Monthly schedule storage
131 Short-distance communication unit
132 Long-distance communication unit
200 Server
300 Air conditioner
1000 Air conditioning data communication system
Bl Bus line
Nw Network

1. An air conditioning data communication device, comprising:
a communicator configured to communicate with a server;
a fee plan storage configured to store fee plan information including a billing cycle under a subscription to a provider of a network used for communications performed by the communicator, a communication volume limit per the billing cycle, and a carryover volume allowance that is a communication volume allowed to be carried over;
a data acquirer configured to acquire data about an air conditioner;
a transmission schedule adjuster configured to create a schedule for transmission of the data acquired by the data acquirer to the server, and to adjust the schedule by changing a transmission time to allow the data to be transmitted to the server when the data is not all transmittable to the server within the billing cycle; and
a data transmitter configured to transmit the data to the server through the communicator in accordance with the schedule obtained by the transmission schedule adjuster,
wherein the transmission schedule adjuster creates, when a volume of data acquired by the data acquirer during the billing cycle is larger than the communication volume limit, a data transmission schedule that allows more data acquired in a high operational period in which the air conditioner operates at a high operating ratio to be transmittable to the server than data acquired in a period other than the high operational period by carrying over, to the high operational period, a communication volume in the period other than the high operational period.

2. (canceled)

3. (canceled)

4. The air conditioning data communication device according to claim 1, wherein
the high operational period includes summer and winter, and
the transmission schedule adjuster sets, when the billing cycle is monthly and the volume of data acquired by the data acquirer during the billing cycle is larger than the communication volume limit, the communication volume to be carried over to the high operational period from the period other than the high operational period to (i) a difference obtained by subtracting the communication volume limit from the volume of data acquired by the data acquirer during the billing cycle or (ii) one third of the carryover volume allowance.

5. The air conditioning data communication device according to claim 1, further comprising:
a communication speed measurer configured to measure a communication speed of the communicator for each time slot,
wherein the transmission schedule adjuster adjusts the schedule when the volume of data acquired by the data acquirer during the billing cycle is larger than a maximum data volume transmittable during the billing cycle calculated from the communication speed for each time slot measured by the communication speed measurer.

6. The air conditioning data communication device according to claim 5, wherein
the transmission schedule adjuster creates a data transmission schedule that allows data in a time slot in which a communication speed measured by the communication speed measurer is lower than a predetermined communication speed taken to transmit the data acquired by the data acquirer to be transmitted to the server in a time slot in which a communication speed measured by the communication speed measurer is higher than the predetermined communication speed.

7. The air conditioning data communication device according to claim 1, further comprising:
a priority data determiner configured to determine whether the data has a high priority,
wherein the transmission schedule adjuster creates a schedule that allows the data determined to have a high priority by the priority data determiner to be transmitted with priority when the data is not all transmittable to the server within the billing cycle.

8. The air conditioning data communication device according to claim 7, wherein
the data having a high priority includes data associated with a malfunction of the air conditioner.

9. The air conditioning data communication device according to claim 1, wherein
the transmission schedule adjuster creates a schedule that allows the data acquired by the data acquirer to be thinned and transmitted when the data is not all transmittable to the server within the billing cycle.

10. The air conditioning data communication device according to claim 1, wherein
the transmission schedule adjuster creates a schedule that allows data obtained by excluding, from the data acquired by the data acquirer, data about the air conditioner in a non-operation state to be transmitted when the data is not all transmittable to the server within the billing cycle.

11. The air conditioning data communication device according to claim 1, further comprising:
a priority-date determiner configured to determine whether a date on which the data is acquired has a high priority,
wherein the transmission schedule adjuster creates a schedule that does not cause transmission of data acquired by the data acquirer on a date determined not to have a high priority by the priority-date determiner when the data is not all transmittable to the server within the billing cycle.

12. An air conditioning data communication method, comprising:
a data acquiring step of acquiring data about an air conditioner;
a fee plan information acquiring step of acquiring fee plan information including a billing cycle under a subscription to a provider of a network used for communications with a server, a communication volume limit per the billing cycle, and a carryover volume allowance that is a communication volume allowed to be carried over;
a transmission schedule adjusting step of creating a schedule for transmission of the data acquired in the data acquiring step to the server, and adjusting the schedule by changing a transmission time to allow the data to be transmittable to the server when the data is not all transmittable to the server within the billing cycle included in the fee plan information acquired in the fee plan information acquiring step; and
a data transmission step of transmitting the data to the server in accordance with the schedule obtained in the transmission schedule adjusting step,
wherein the transmission schedule adjusting step includes creating, when a volume of data acquired in the data acquiring step during the billing cycle is larger than the communication volume limit, a data transmission schedule that allows more data acquired in a high operational period in which the air conditioner operates at a high operating ratio to be transmittable to the server than data acquired in a period other than the high operational period by carrying over, to the high operational period, a communication volume in the period other than the high operational period.

13. A non-transitory computer-readable recording medium storing a program causing a computer to implement:
a data acquiring step of acquiring data about an air conditioner;
a fee plan information acquiring step of acquiring fee plan information including a billing cycle under a subscription to a provider of a network used for communications with a server, a communication volume limit per the billing cycle, and a carryover volume allowance that is a communication volume allowed to be carried over;
a transmission schedule adjusting step of creating a schedule for transmission of the data acquired in the data acquiring step to the server, and adjusting the schedule by changing a transmission time to allow the data to be transmittable to the server when the data is not all transmittable to the server within the billing cycle included in the fee plan information acquired in the fee plan information acquiring step; and
a data transmission step of transmitting the data to the server in accordance with the schedule obtained in the transmission schedule adjusting step,
wherein the transmission schedule adjusting step includes creating, when a volume of data acquired in the data acquiring step during the billing cycle is larger than the communication volume limit, a data transmission schedule that allows more data acquired in a high operational period in which the air conditioner operates at a high operating ratio to be transmittable to the server than data acquired in a period other than the high operational period by carrying over, to the high operational period, a communication volume in the period other than the high operational period.
